(19) United States
(12) Patent Application Publication
(10) Pub. No.: US 2023/0055954 A1
(43) Pub. Date: Feb. 23, 2023

(54) METHOD FOR ADHESION FORCE PREDICTION THROUGH SEQUENTIAL CONTACT ANALYSIS OF NANO-ASPERITY AND RECORDING MEDIUM RECORDING PROGRAM FOR PERFORMING THE METHOD

(71) Applicant: KOREA ADVANCED INSTITUTE OF SCIENCE AND TECHNOLOGY, Daejeon (KR)

(72) Inventors: Jun-Bo YOON, Daejeon (KR); Su-hyun KIM, Daejeon (KR); Yong-bok LEE, Daejeon (KR); Pan-kyu CHOI, Daejeon (KR); Tae-Soo KIM, Daejeon (KR)

(73) Assignee: KOREA ADVANCED INSTITUTE OF SCIENCE AND TECHNOLOGY, Daejeon (KR)

(21) Appl. No.: 17/537,841

(22) Filed: Nov. 30, 2021

(30) Foreign Application Priority Data
Aug. 18, 2021 (KR) 10-2021-0108818

(51) Int. Cl. G01N 19/04; G06F 30/23; G06F 17/10

(52) U.S. Cl. CPC G01N 19/04; G06F 30/23; G06F 17/10; G06F 2111/10

(57) ABSTRACT

Disclosed are a method using a sequential contact analysis of a nano-asperity in order to predict an adhesion force between two contacting surfaces and a recording medium recording a program. According to an exemplary embodiment, the method may include: receiving surface roughness data of each of the two target objects; modeling a rough surface based on the surface roughness data; computing an adhesion force value when the two target objects contact and a deformation value of the first nano-asperity; determining whether a next contact is established; iteratively performing the computing and the determining when the deformation value of the first nano-asperity is larger than the separation distance of the next nano-asperity; and determining that a next contact is not established and computing and outputting force adhesion force in a final contact situation, when the deformation value of the first nano-asperity is smaller than the separation distance of the next nano-asperity.

### CROSS-REFERENCE TO RELATED APPLICATIONS

This application claims priority to and the benefit of Korean Patent Application No. 10-2021-0108818 filed in the Korean Intellectual Property Office on Aug. 18, 2021, the entire contents of which are incorporated herein by reference.

### TECHNICAL FIELD

The present invention relates to a method using a sequential contact analysis of a nano-asperity in order to predict an adhesion force between two contacting surfaces and a recording medium recording a program for performing the method.

### BACKGROUND ART

When two surfaces contact or is close to contact, an attraction that causes adhesion is generated between two surfaces. An adhesion force is a force required for separating the two surfaces. In a ‘macro scale’, an influence of the adhesion force is slight, but in a ‘micro/nano scale’, the influence of the adhesion force increases, and as a result, the adhesion force is a very important consideration in various fields of micro/nanotechnology. Accordingly, precise prediction and analysis of the adhesion force are required.

In particular, the adhesion force is considered to be important in the following nanotechnology field. The adhesion in a biology field plays an important role in maintaining a structural stability of a cell and going through morphogenetic process, and becomes a principle for measuring a surface morphology in a measurement equipment such as an atomic force microscopy. In addition, in the case of Micro/Nano Electro Mechanical System (M/NEMS) field, the adhesion force may become a failure mechanism that causes stiction or a method for achieving high performance of a device by intentionally causing the stiction. As described above, since the adhesion force is regarded as an important element in various application fields, the prediction and the analysis of the adhesion force are particularly required.

For precise prediction of adhesion force generated between two surfaces which actually contact, 1) a contact analysis and 2) an adhesion analysis are required.

In the case of the contact analysis, analysis of deformation, contact region, and a separation distance between two contacting nano asperities is required. FIG. 1 is a diagram illustrating a contact state change of a nano-asperity by external force or adhesion force.

The adhesion analysis needs to consider a force suitable for contact material and a situation. FIG. 2 is a diagram illustrating an example of a force suitable for a contact material and a situation. Referring to FIG. 2, as an example of the force suitable for the contact material and the situation, there are a van der Waals force (vdW force) and a metallic bonding force. The Van der Waals force is ‘force’ continuously present among all materials from an interatomic spacing (approximately 0.2 nm) to a distance of 10 nm or more as illustrated in an upper diagram of FIG. 2. A metal coupling bonding force is a force generated by electron exchange interactions between metallic surfaces in a very close distance (within 0.2 nm) as illustrated in a lower diagram of FIG. 2.

As an adhesion force prediction model in the related art, there is an existing adhesion force prediction model (see Non-Patent Documents 1, 2, and 3) that performs only the adhesion analysis according to the separation distance without the contact analysis and there is an existing adhesion force prediction model (Non-patent Document 4) having a very narrow use range by calculating the adhesion force by considering only elastic deformation and the van der Waals force.

The adhesion force prediction models in the related art are impossible to actually utilize because the separation distance between the nano-asperities cannot be known due to the absence of the contact analysis, and impossible to apply to contact situations with various contact materials because a range of plastic deformation is not analyzed and a metallic bonding force is not considered. Further, since one surface of two contacting surfaces is assumed as an ideal flat surface, an error rate due to excessive simplification increases. Moreover, the adhesion force prediction models in the related art are not verified through a comparison with experimental results.

### PRIOR ART DOCUMENT

### Non-Patent Document

(Non-Patent Document 1) Journal of Adhesion Science and Technology. 1996, 10.2, 161-175.
(Non-Patent Document 2) Wear. 1994, 174.1-2, 9-19.
(Non-Patent Document 3) Journal of Tribology. 1988, 110.1, 50-56.
(Non-Patent Document 4) Nature Materials. 2005, 4. 8, 629-634.

### SUMMARY OF THE INVENTION

The present invention has been made in an effort to provide a method for adhesion force prediction, which can be actually utilized, and has a wide use range and high accuracy, and a recording medium recording a program for performing the method.

An exemplary embodiment of the present invention provides a method for adhesion force prediction as a method for predicting adhesion force between two target objects, which includes: receiving surface roughness data of each of the two target objects; modeling a rough surface in which a first nano-asperity contacts based on the surface roughness data; computing an adhesion force value when the two target objects contact and a deformation value of the first nano-asperity in the modeling; determining whether a next contact is established by comparing the deformation value of the first nano-asperity and a separation distance of a next nano-asperity to contact just next; iteratively performing the computing and the determining when the deformation value of the first nano-asperity is larger than the separation distance of the next nano-asperity; and determining that a next contact is not established and computing and outputting final adhesion force in a final contact situation, when the deformation value of the first nano-asperity is smaller than the separation distance of the next nano-asperity.

Here, the surface roughness data may include height data for each location of each of the two target objects, and the contact of the first nano-asperity may be determined by <Equation> below:

Location of first real contact=Max(Heightₜₒₚ+Height_{bottom}) <Equation>

The Heighttop represents a height of multiple nano-asperities formed on a surface of any one of the two target objects, and the Heightbottom represents a height of multiple nano-asperities formed on a surface of the other one of the two target objects.

Here, when the both the two target objects are metal, as the adhesion force value, at least, vdW force may be computed in an entire region and metallic bonding force may be computed in a contact region, in the computing.

Here, when the both the two target objects are non-metal, as the adhesion force value, at least, the vdW force may be computed in the entire region in the computing.

Here, in the computing, when the deformation value of the first nano-asperity is smaller than a critical deformation value, a corresponding region may be distinguished as an elastic deformation region, and when the deformation value of the first nano-asperity is larger than the critical deformation value and smaller than 110 times of the critical deformation value, the corresponding region may be distinguished as an elastic-plastic deformation region which is an intermediate region of elastic deformation and plastic deformation, and when the deformation value of the first nano-asperity is larger than 100 times of the critical deformation value, the corresponding region may be distinguished as the plastic deformation region, and the deformation value of the first nano-asperity may be computed by using predetermined methods which are different for each the elastic deformation region, the elastic-plastic deformation region, and the plastic deformation region.

Here, when the deformation value of the first nano-asperity is computed in the elastic region, a JKR model or a DMT model which are theories dealing with an elastic contact of a sphere may be used, and by which model of the JKR model and the DMT model the deformation value is computed may be determined by a tabor parameter which becomes a use criterion of the JKR model and the DMT model.

Here, when the deformation value of the first nano-asperity is computed in the elastic-plastic region, the deformation value may be computed by using four adhesion force equations distinguished according to two criteria by using a Kagot etsion's model.

Here, when deformation value of the first nano-asperity is computed in the plastic region, the deformation value may be computed by using a Johnson's theory.

Another exemplary embodiment of the present invention provides a computer readable recording medium recording a computer program for performing the method for adhesion force prediction.

According to exemplary embodiments of the present invention, in a method for adhesion force prediction method and a recording medium recording a program for performing the same method, there is an advantage in that the method and the recording medium can be actually utilized, and have a wide use range and high accuracy.

There is an advantage in that a sequential contact situation of an actual contacting nano-asperities can be simulated.

There is an advantage in that elastic deformation and plastic deformation of nano-asperities can be considered.

There is an advantage in that the method and the recording medium can be used in all materials and contact situations.

There is an advantage in that it is verified that the method for the adhesion force prediction has a low error rate through comparison with experiment value.

### BRIEF DESCRIPTION OF THE DRAWINGS

FIG. 1 is a diagram illustrating a contact state change of nano-asperities by external force or adhesion force.

FIG. 2 is a diagram illustrating an example of an attractive force suitable for a contact material and a situation.

FIG. 3 is a flowchart of a method for adhesion force prediction according to an exemplary embodiment of the present invention.

FIG. 4 is a diagram for describing an example of a step of measuring surface roughness of two objects for predicting adhesion force.

FIG. 5 is a diagram for describing an example of a step of modeling a rough surface.

FIG. 6 is a diagram for schematically describing an iteration process in a method for adhesion force prediction according to an exemplary embodiment of the present invention.

FIG. 7 is a diagram for describing an example of computing deformation of a nano-asperity.

FIG. 8 exemplarily illustrates a method which may be applied in an elastic deformation region illustrated in FIG. 7.

FIG. 9 exemplarily illustrates a method which may be applied in an elastic-plastic deformation region illustrated in FIG. 7.

FIG. 10 exemplarily illustrates a method which may be applied in a plastic deformation region illustrated in FIG. 7.

FIGS. 11 and 12 are schematic diagrams for describing an iteration process in which S300, S400, and S500 illustrated in FIG. 3 are iterated.

FIG. 13 is a diagram exemplarily illustrating a situation in which a next contact is not established in S500 illustrated in FIG. 3.

FIG. 14 is a diagram illustrating an example of a device configuration of atomic force microscope (AFM) Force-distance (F-d) measurement.

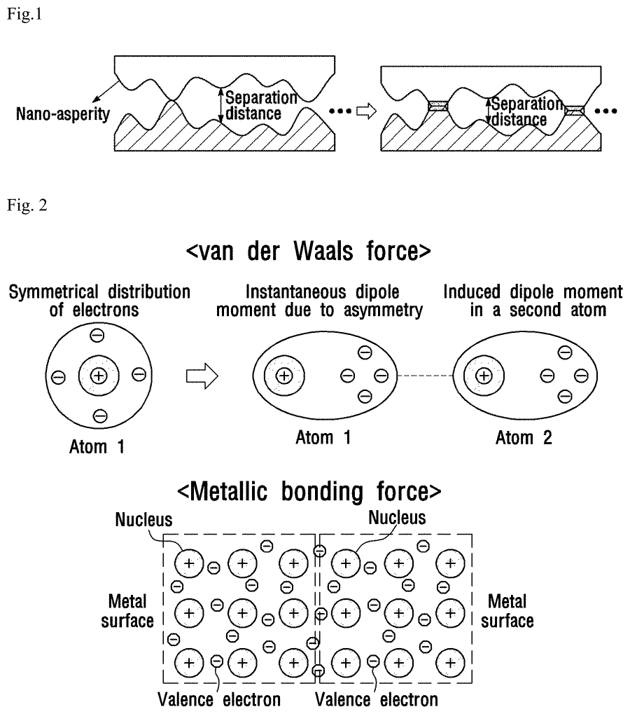

### DETAILED DESCRIPTION

The following detailed description of the present invention will be made with reference to the accompanying drawings which illustrate a specified exemplary embodiment in which the present invention may be implemented as an example. The exemplary embodiment will be described in detail enough so that those skilled in the art are able to embody the present invention. It should be understood that various exemplary embodiments of the present invention are different from each other and need not be mutually exclusive. For example, specific shapes, structures, and characteristics described herein may be implemented in other exemplary embodiments without departing from the spirit and scope of the present invention in relation to one exemplary embodiment. In addition, it is to be understood that the location or arrangement of individual components within each disclosed exemplary embodiment may be changed without departing from the spirit and scope of the present invention. Accordingly, the detailed description to be described below is not intended to be taken in a limiting sense, and the scope of the present invention, if properly described, is limited only by the appended claims, along with all scopes equivalent to those claimed by the claims. Similar reference numerals in the drawings designate the same or similar functions in many aspects.

Hereinafter, preferred exemplary embodiments of the present invention will be described in detail with reference to the accompanying drawings so that those skilled in the art may easily implement the present invention.

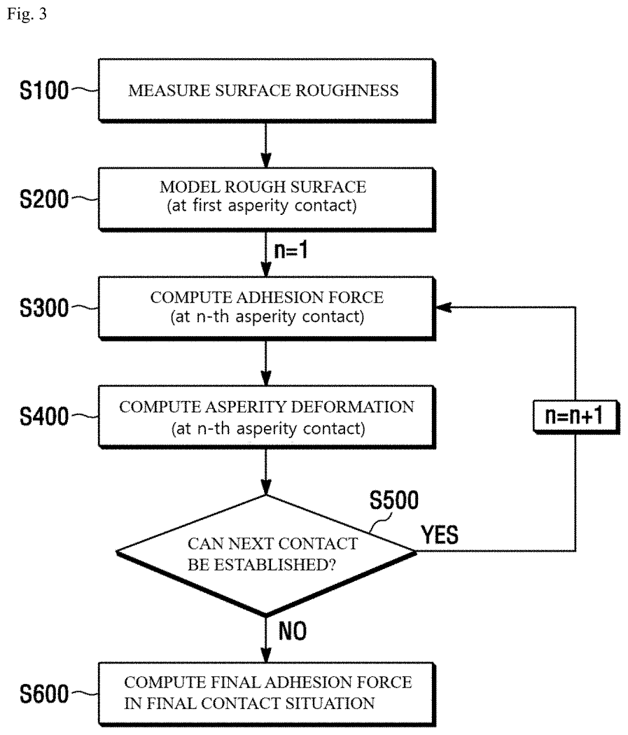

FIG. 3 is a flowchart of a method for adhesion force prediction according to an exemplary embodiment of the present invention.

The method for adhesion force prediction according to the exemplary embodiment of the present invention may be actually utilized, and has high accuracy. In particular, the method for adhesion force prediction simulates a sequential contact situation of the nano-asperities on an actual rough surface, considers both elastic deformation and plastic deformation ranges, and may be utilized in the both metallic and non-metallic contacts.

The method for adhesion force prediction according to the exemplary embodiment of the present invention includes an iteration process for a sequential analysis of contacting region, deformation, and adhesion force of the nano-asperity. Specifically, the method may include a contact analysis and an adhesion analysis, and here, in the contact analysis, the elastic deformation and the plastic deformation of the nano-asperities are considered based on actual contact environment data, and in the adhesion analysis, adhesion (vdW force and/or metallic bonding force) suitable for the contact material and the distance is analyzed. Hereinafter, the method will be described in more detail with reference to FIG. 3.

Referring to FIG. 3, the method for adhesion force prediction according to the exemplary embodiment of the present invention includes measuring surface roughness (S100), modeling the rough surface (S200), computing the adhesion force (S300), computing asperity deformation (S400), determining whether a next contact is established (S500), and computing final adhesion force in a final contact situation (S600).

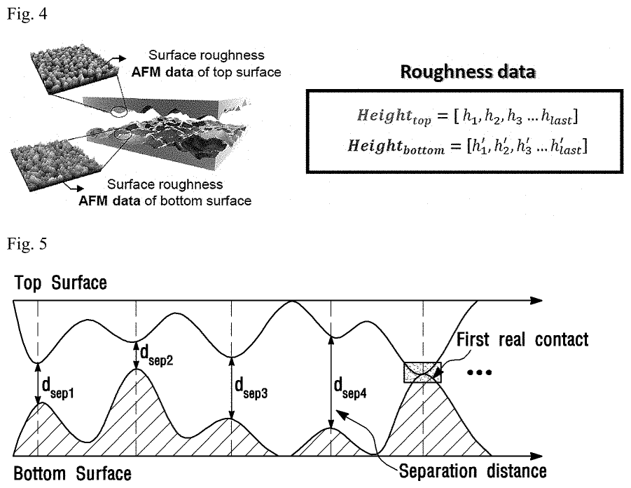

The measuring of the surface roughness (S100) is a step of acquiring data of an actual surface environment of two objects which are objects of which adhesion force is to be predicted. FIG. 4 is a diagram for describing an example of a step of measuring surface roughness of two objects for predicting adhesion force. Referring to FIG. 4, roughness data of a contact surface of each of two objects may be acquired by using a non-contact mode of the AFM device. The acquired roughness data may be height data for each location of each contact surface.

The modeling of the rough surface (S200) is a step of modeling the rough surface of each of two contacting objects by using the roughness data acquired in step S100 above. Here, the modeling of the rough surface (S200) may be performed by a modeling unit of a device for performing the method for adhesion force prediction according to the exemplary embodiment of the present invention.

FIG. 5 is a diagram for describing an example of a step of modeling a rough surface. Referring to FIG. 5, the modeling of the rough surface (S200) may be a step of modeling the rough surface in which a first nano-asperity contact is made based on the roughness data. Here, the first nano-asperity contact may be determined by <Equation 1> below.

Location of first real contact=Max(Heightₜₒₚ+Height_{bottom}) [Equation 1]

In <Equation 1> above, the Heighttop represents a height of multiple nano-asperities formed on a surface of any one of the two target objects, and the Heightbottom represents a height of multiple nano-asperities formed on a surface of the other one of the two target objects.

In the modeling of the rough surface (S200), since a nano-asperity in which a first contact is made is determined, separation distances dsep1, dsep2, dsep3, and dsep4 of other non-contacting nano-asperities may be known based thereon.

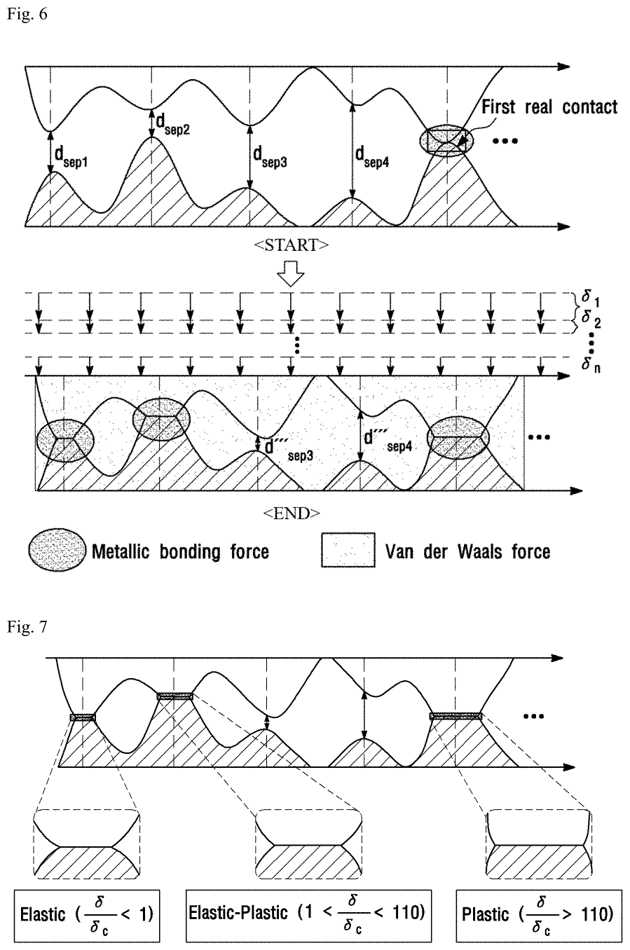

The computing of the adhesion force (S300), the computing of the asperity deformation (S400), and the determining of whether the next contact is established (S500) as a process of performing the sequential contact analysis and adhesion analysis of the nano-asperity is an iteration process. The iteration process starts from a time when a first contact of two nano-asperities occurs and ends when an additional nano-asperity contact does not occur because the deformation of the nano-asperity does not occur any longer, as illustrated in FIG. 6. Hereinafter, the steps of the iteration process will be described.

In order to know how the nano-asperities which contact each other are deformed, it should be known how large force is applied between two surfaces. Accordingly, the computing of the adhesion force (S300) is required before computing the deformation of the nano-asperity. Two types of forces are generally applied to the surface. The first force is external force applied from the outside and the second force is adhesion force between the two surfaces. Since it may be accurately computed how the nano-asperity is to be deformed only by calculating an adhesion force value, the adhesion force value in a given separation distance is computed first. In this case, when both two target objects are metal, the vdW force may be computed in an entire region, and the metallic bonding force may be computed in the contact region, and when both two target objects are non-metal, the vdW force may be computed in the entire region as the adhesion force value. It is natural that another force may be further additionally considered in addition to the vdW force and the metallic bonding force. For example, electrostatic force generated between two interfaces charged due to unbalance of electrons or ions, and liquid menisci between two solid surfaces are formed, and there are capillary force, H-bridging which is electrostatic attraction generated between hydrogen bond and electronegative atom, etc.

After the adhesion force value is computed, the deformation of the nano-asperity is computed (S400). A target for which the deformation of the nano-asperity is computed is a first contacting nano-asperities. How the first contacting nano-asperities are deformed when given force is applied is computed by using a predetermined method. Here, it should be noted that as the predetermined method, several following methods are provided, but the predetermined method is not limited thereto.

As an example of computing the deformation of the nano-asperity, there is a method using a critical deformation value. The critical deformation value Sc as a deformation value in which the plastic deformation starts may be defined by <Equation 2> below.

$${δ}_{C} = {( \frac{π CH}{2 {E}^{*}} )}^{2} R , \qquad [ Equation 2 ]$$

$$wherein ,$$

$$\begin{matrix}C = 0.454 + 0.41 v \\ \frac{1}{{E}^{*}} = \frac{1 - {v}_{1}^{2}}{{E}_{1}} + \frac{1 - {v}_{2}^{2}}{{E}_{2}}\end{matrix}$$

In Equation 2 above, C represents a hardness coefficient, v, v1, and v2 represent a Poisson's ration, R represents a radius of curvature, H represents hardness of the material, and E1 and E2 represent Young's modulus.

FIG. 7 is a diagram for describing an example of computing deformation of a nano-asperity.

Referring to FIG. 7, when a deformation value δ of two contact nano-asperities is smaller than the critical deformation value δ_{c}, the elastic deformation region is defined and when δ is larger than δ_{c}, and smaller than 110 times of δ_{c}, the elastic-plastic deformation region which is an intermediate region of the elastic deformation and the plastic deformation is defined, and when δ is larger than 110 times of δ_{c}, the plastic deformation region is defined.

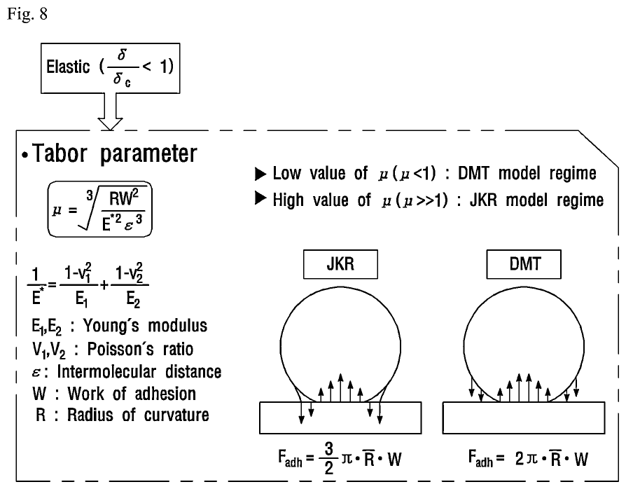

A predetermined theory or model may be applied for each of three regions. The method will be described below with reference to FIGS. 8 to 10.

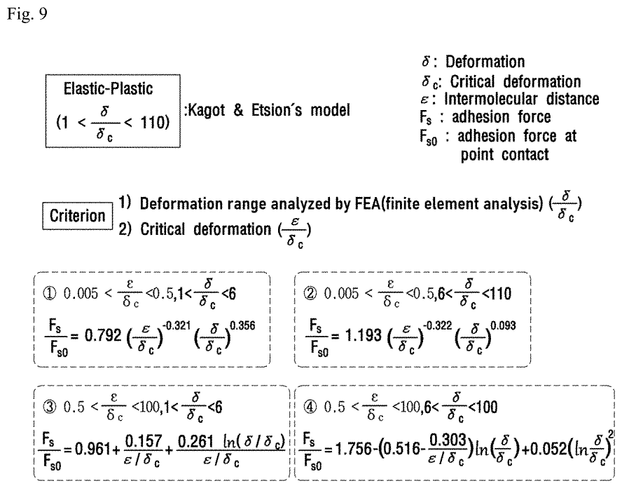

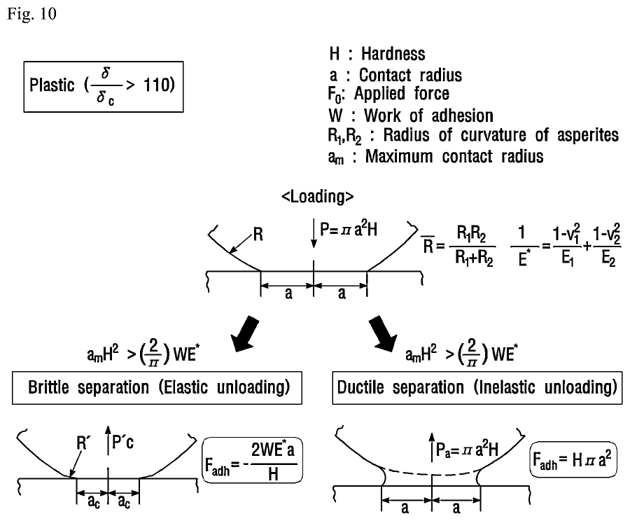

FIG. 8 exemplarily illustrates a method which may be applied in an elastic deformation region illustrated in FIG. 7, FIG. 9 exemplarily illustrates a method which may be applied in an elastic-plastic deformation region illustrated in FIG. 7, and FIG. 10 exemplarily illustrates a method which may be applied in a plastic deformation region illustrated in FIG. 7.

Referring to FIG. 8, when the deformation of the nano-asperity the elastic deformation region is considered, a JKR model and a DMT model may be used, which are theories that handle an elastic contact of a sphere.

The JKR model which is a first theory to deal with the elastic contact of Hertz theory (sphere) in the related art as a model proposed by introducing surface energy into the Hertz theory in order to improve an accuracy defining a relationship between applied force and a contact radius, and deformation of asperity computes the contact radius by using applied load (F) considering the adhesion force. In the JKR model, the contact radius and the deformation value of the asperity are determined at a point where total potential energy of the sphere is minimized. Here, an interaction generated outside the contact region is ignored.

The DMT model as a model in which an entire attraction is outside the contact region and a balance is achieved by Hertzian compression is a model suitable for a material which has high surface energy and is hard, such as metal.

Which model of the two models the contact radius is to be computed may be determined as a Tabor parameter (Tabor, D., “Surface forces and surface interactions.” Plenary and invited lectures. Academic Press, 1977., 3-14.) which becomes a use reference of the two models. Here, for a soft material, a JKR theory may be used and for a hard material, a DMT theory may be used.

Referring to FIG. 9, in the case of the elastic-plastic region, a Kagot etsion's model (Kogut, Lior, and Izhak Etsion., “Adhesion in elastic-plastic spherical microcontact.” Journal of Colloid and Interface Science 261.2 (2003): 372-378.) may be used. Specifically, four adhesion force equations distinguished according to two criteria may be used. In more detail, a section before entering an intact plastic deformation region is divided into two sections and different equations may be used according to a tendency, and the corresponding equation is divided once more according to critical deformation (ε/δ_{c}) and divided into a total of four equations, and an equation suitable for the situation and the material may be used. Here, if characteristics of a contact situation or a material to be used do not match a range handled by the Kagot etsion's model, another theory which handles the adhesion force of the elastic-plastic region may be applied.

Referring to FIG. 10, in the case of the plastic region, a Johnson's theory may be used. The Johnson's theory is divided into brittle separation and ductile separation in an unloading process after loading, and is a theory that uses a predetermined equation according to which separation occurs according to the material and a deformation.

Referring back to FIG. 3, in the determining of whether the next contact is established (S500), whether the next contact is established is determined by comparing the deformation value of the first contacting nano-asperity with a separation distance value of a nano-asperity which is anticipated to contact next (hereinafter, referred to as ‘next contacting nano-asperities’). Here, the next contacting nano-asperities may also be defined as two nano-asperities having the shortest separation distance.

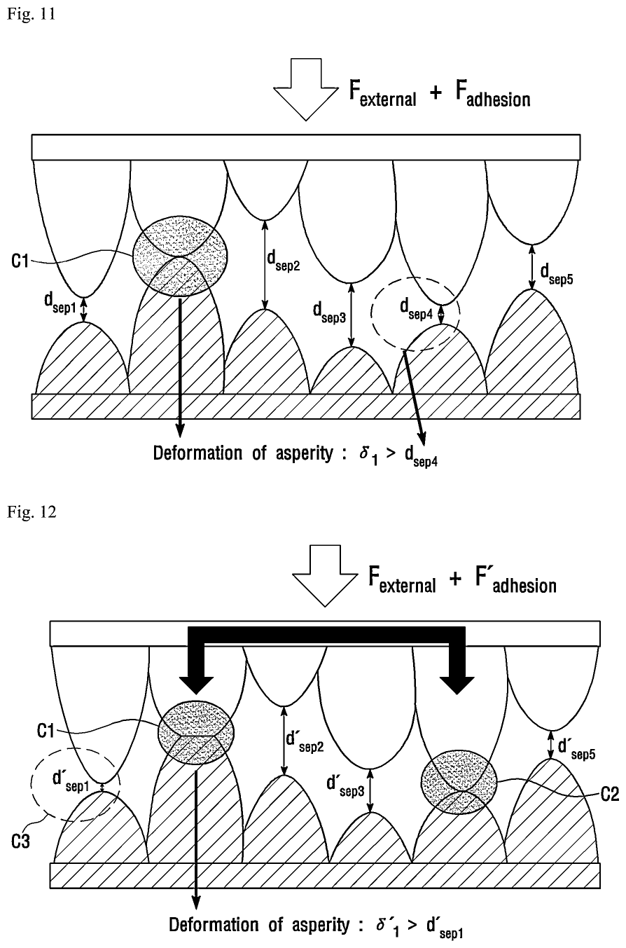

If the deformation value of the first contacting nano-asperities is larger than the separation distance of the next contacting nano-asperities, it is determined that the next (n+1) nano-asperity contacts and in the case where the next (n+1) nano-asperity contacts, steps S300, S400, and S500 are iterated. The iteration process will be described with reference to FIGS. 11 and 12.

FIGS. 11 and 12 are schematic diagrams for describing an iteration process in which S300, S400, and S500 illustrated in FIG. 3 are iterated. FIG. 11 exemplarily illustrates a situation in which two nano-asperities contact (C1) first and FIG. 12 exemplarily illustrates a situation in which two nano-asperities contact (C2) second.

Referring to FIG. 11, when the nano-asperity contacts first (C1), an adhesion fore value F_{adhesion} is computed (S300) and after a deformation value δ1 of the first contacting nano-asperities (S400), the deformation value δ1 of the first contacting nano-asperities is compared with a separation distance dₛₑₚ₄ of two nano-asperities to contact second. As a comparison result, when M is larger than dₛₑₚ₄, it is determined that the contact (C2) of two nano-asperities having the separation distance of dₛₑₚ₄ is possible.

Referring to FIG. 12, when the second nano-asperity contacts (C2), separation distances d′ₛₑₚ₁, d′ₛₑₚ₂, d′ₛₑₚ₃, and d′ₛₑₚ₅ between other nano-asperities increase because two surfaces are closer to each other than as illustrated in FIG. 11, and as a result, the second nano-asperity is newly defined. Since the adhesion force value also varies due to the separation distances d′ₛₑₚ₁, d′ₛₑₚ₂, d′ₛₑₚ₃, d′ₛₑₚ₅ and the change in the number of contacting nano-asperities, S300, S400, and S500 are iterated again. Specifically, since the number of contacting nano-asperities and the adhesion force value F′_{adhesion} vary due to the contact of the second nano-asperities (C2), the deformation degree of the first contacting nano-asperities also varies, and as a result, a deformation value δ′1 of the first contacting nano-asperities is computed again. When the computed δ′1 is larger than the separation distance d′ₛₑₚ₁ of two nano-asperities to contact third, it is determined that the contact of the third nano-asperity (C3) is possible.

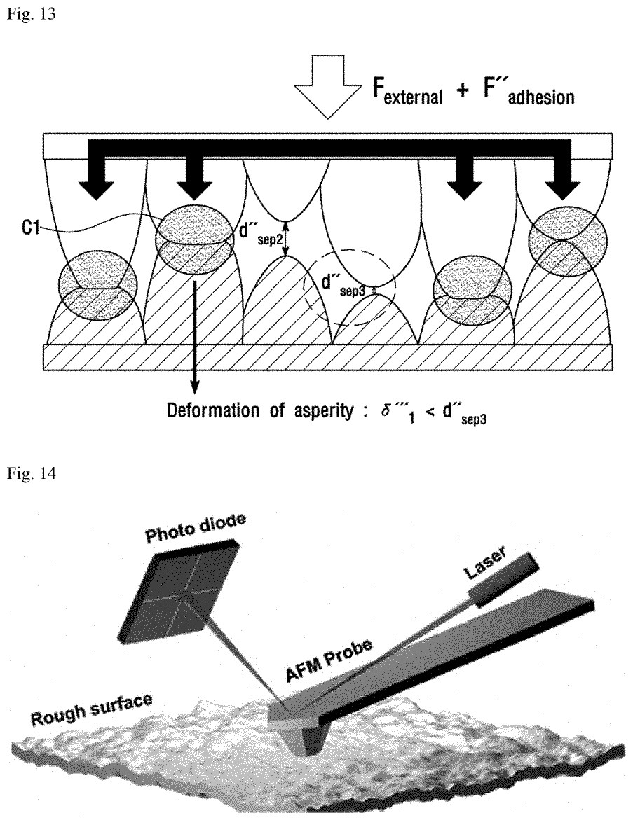

Continuously, as illustrated in FIGS. 11 and 12, a process is continuously iterated, in which the adhesion force value is calculated and the deformation value of the first nano-asperity is computed, and then whether the next contact may be established is determined. For example, a time when n-th contact is reached after processes of multiple times such as 10 times, 50 times, 100 times, etc., are performed will be described with reference to FIG. 13.

FIG. 13 is a diagram exemplarily illustrating a situation in which a next contact is not established in S500 illustrated in FIG. 3.

Referring to FIG. 13, an adhesion force value F″_{adhesion} is computed even in a final contact state and a deformation value δ″1 of a first nano-asperities is computed, and when δ″1 is smaller than the separation distance d″ₛₑₚ₃ of the next contacting nano-asperities, it is determined that the next contacting nano-asperities does not contact. When the determination is made as such, the situation illustrated in FIG. 13 becomes a final contact situation in which two surfaces may finally contact. In the final contact situation, computing and outputting final adhesion force (S600) is performed.

In the computing of the final adhesion force (S600), the separation distance, and the contact and deformation states of the nano-asperity in the final contact situation are all aggregated, and as a result, as in <End> of FIG. 6, the final adhesion force value is computed by considering the vdW force, in overall, the metallic bonding force in a portion(s) which contacts the nano-asperity.

Meanwhile, S300, S400, S500, and S600 may be performed by a computation unit of the device performing the method for adhesion force prediction according to the exemplary embodiment of the present invention. For example, the computation unit may be a processor.

The present inventor(s) compared the adhesion force by the method for adhesion force prediction according to the exemplary embodiment of the present invention and adhesion force measured through an actual experiment (AFM Force-distance (F-d) measured), for each of two samples. Here, the AFM does not have a function to measure the surface roughness, but when a Force-distance (F-d) measurement function is used, adhesion force between the corresponding sample and a tip may be quantitatively sought. FIG. 14 is a diagram illustrating an example of a device configuration of AFM Force-distance (F-d) measurement. When the AFM F-d measurement is performed by using the device illustrated in FIG. 14, a plateau type tip is used to implement surface to surface contact.

As a comparison result, in the case of a molybdenum (Mo)—Mo (metallic) contact sample, when applied pressure is 4.9 to 49 [kN/m2] and RMS roughness of the sample is within a range of 3.7 to 5.6 nm, the adhesion force by the method for adhesion force prediction according to the exemplary embodiment of the present invention is compared with actually measured adhesion force to confirm that an average error rate is 6.55% and a maximum error rate is 12.4%.

Further, in the case of a silicon (Si)—Si (non-metallic) contact sample, when applied pressure is 2.27 to 20.45 [kN/m2] and RMS roughness of the sample is within a range of 1.9 to 11.4 nm, the adhesion force by the method for adhesion force prediction according to the exemplary embodiment of the present invention is compared with actually measured adhesion force to confirm that an average error rate is 2.88% and a maximum error rate is 5.41%.

Referring to a comparison result of two samples, there is no significant difference even between the method for adhesion force prediction according to the exemplary embodiment of the present invention and an actual measurement value, and it may be confirmed that higher accuracy is provided than existing adhesion force prediction methods showing low accuracy (a minimum error rate between an experiment value and a calculation value: 25%).

As described above, when the method for adhesion force prediction according to the exemplary embodiment of the present invention is used, an adhesion force prediction model which may be actually utilized, and has a wide use range and high accuracy may be implemented. In particular, the adhesion force may be calculated by using a sequential contact analysis of the nano-asperity by reflecting an actual contact environment, the method is verified through the experiment, and the method may be used in contact situations of all types of surfaces (e.g., metallic contact or non-metallic contact), both elastic and plastic deformation ranges are considered, and the method may be actually utilized by computing the separation distance between the nano-asperities.

The method may also be utilized for an application field requiring precise adhesion force prediction like a design of adhesion force of a high-performance micro/nano-device.

The method for adhesion force prediction according to the exemplary embodiment of the present invention may infer a location, a contact radius, a contact area, etc., of the contacting nano-asperity when a specific contact surface is generated, and predict even contact resistance of two contacting surface based on the contact radius and contact area analysis of the nano-asperity.

Meanwhile, the method for adhesion force prediction according to the exemplary embodiment of the present invention may be carried out through a computer readable recording medium including a program command for performing an operation implemented by a computer. The computer readable recording medium may include the program command, a data file, or a data structure singly or a combination thereof. The recording medium may be specially designed and configured for the present invention for the exemplary embodiment, or may be publicly known to and used by those skilled in the computer software field. Examples of the computer readable recording medium include magnetic media such as a hard disk, a floppy disk, and a magnetic tape, optical recording media such as a CD-ROM and a DVD, magneto-optical media such as a floptical disk, and a hardware device which is specifically configured to store and execute the program command such as a ROM, a RAM, and a flash memory. An example of the program command includes a high-level language code executable by a computer by using an interpreter and the like, as well as a machine language code created by a compiler.

Hereinabove, the exemplary embodiments have been described with reference to the accompanying drawings, but these are merely examples and do not limit the present invention, and those skilled in the art to which the present invention pertains will know that various modifications and applications not illustrated above can be made within the scope without departing from the essential characteristics of the exemplary embodiment. For example, each component specifically shown in the exemplary embodiment may be implemented by being modified. In addition, it will be interpreted that differences related to the modifications and applications are included in the scope of the present invention defined in the appended claims.

1. A method for predicting adhesion force between two target objects, the method comprising:
receiving surface roughness data of each of the two target objects;
modeling a rough surface in which a first nano-asperity contacts based on the surface roughness data;
computing an adhesion force value when the two target objects contact and a deformation value of the first nano-asperity in the modeling;
determining whether a next contact is established by comparing the deformation value of the first nano-asperity and a separation distance of a next nano-asperity to contact just next;
iteratively performing the computing and the determining when the deformation value of the first nano-asperity is larger than the separation distance of the next nano-asperity; and
determining that a next contact is not established and computing and outputting final adhesion force adhesion force in a final contact situation, when the deformation value of the first nano-asperity is smaller than the separation distance of the next nano-asperity.

2. The method of claim 1, wherein the surface roughness data includes height data for each location of each of the two target objects, and
the contact of the first nano-asperity is determined by <Equation> below:
Location of first real contact=Max(Heightₜₒₚ+Height_{bottom}) <Equation>
the Heightₜₒₚ represents a height of multiple nano-asperities formed on a surface of any one of the two target objects, and
the Height_{bottom} represents a height of multiple nano-asperities formed on a surface of the other one of the two target objects.

3. The method of claim 1, wherein when the both the two target objects are metal, as the adhesion force value, at least, vdW force is computed in an entire region and metallic bonding force is computed in a contact region, in the computing.

4. The method of claim 1, wherein when the both the two target objects are non-metal, as the adhesion force value, at least, the vdW force is computed in the entire region in the computing.

5. The method of claim 1, wherein in the computing, when the deformation value of the first nano-asperity is smaller than a critical deformation value, a corresponding region is distinguished as an elastic deformation region, and when the deformation value of the first nano-asperity is larger than the critical deformation value and smaller than 110 times of the critical deformation value, the corresponding region is distinguished as an elastic-plastic deformation region which is an intermediate region of elastic deformation and plastic deformation, and when the deformation value of the first nano-asperity is larger than 110 times of the critical deformation value, the corresponding region is distinguished as the plastic deformation region, and the deformation value of the first nano-asperity is computed by using predetermined methods which are different for each the elastic deformation region, the elastic-plastic deformation region, and the plastic deformation region.

6. The method of claim 5, wherein when the deformation value of the first nano-asperity is computed in the elastic deformation region, a JKR model or a DMT model which are theories dealing with an elastic contact of a sphere are used, and by which model of the JKR model and the DMT model the deformation value is computed is determined by a tabor parameter which becomes a use criterion of the JKR model and the DMT model.

7. The method of claim 5, wherein when the deformation value of the first nano-asperity is computed in the elastic-plastic deformation region, the deformation value is computed by using four adhesion force equations distinguished according to two criteria by using a Kagot etsion's model.

8. The method of claim 5, wherein when deformation value of the first nano-asperity is computed in the plastic deformation region, the deformation value is computed by using a Johnson's theory.

9. A computer readable recording medium recording a computer program for performing the method for adhesion force prediction of claim 1.
